(19) United States
(12) Patent Application Publication
(10) Pub. No.: US 2003/0079190 A1
(43) Pub. Date: Apr. 24, 2003

(54) Method for deriving a hierarchical functional description of a circuit

(76) Inventors: Atanas Nikolaev Parashkevov, Valley View (AU); Simon Thomas Jolly, Everald Park (AU); Timothy David McDougall, St. Morris (AU)

Correspondence Address: MOTOROLA, INC., 1303 EAST ALGONQUIN ROAD, IL01/3RD, SCHAUMBURG, IL, 60196

(21) Appl. No.: 10/253,619

(22) Filed: Sep. 24, 2002

Related U.S. Application Data
(63) Continuation-in-part of application No. 10/218,358, filed on Aug. 14, 2002.
(63) Continuation-in-part of application No. 09/643,050, filed on Aug. 21, 2000, now abandoned.

(51) Int. Cl. G06F 17/50

(52) U.S. Cl. 716/4; 716/5; 716/2; 716/18

(57) ABSTRACT

A method for deriving a hierarchical functional description of a circuit by creating a hierarchical model of the circuit from the initial hardware description (100), the hierarchical model having at least one boundary connection coupling hierarchical levels of the model. Signal flow conflicts at each boundary connection are then analyszd (101) which includes flattening (205) instances of the hierarchical model where signal flow conflicts are identified thereby transforming the hierarchical model into a signal flow conflict free hierarchical model. A hierarchical functional description of the circuit is then derived (102) from the signal flow conflict free hierarchical model.

### FIELD OF THE INVENTION

This application is a Continuation In Part of U.S. patent application Ser. No. 10/218,358 filed on Aug. 14, 2002. This invention relates to a method for deriving a hierarchical functional description of a circuit. The hierarchical functional description alleviates signal flow conflicts and is derived from a hardware description typically containing logic gates, logic switches or combinations thereof.

### BACKGROUND ART

Contemporary chip design depends critically on the availability of appropriate Computer Aided Design (CAD) tools in order to keep up with the ever-increasing chip complexity. Designers typically work with chip descriptions at several levels of abstraction. For example, a Register-Transfer Level (RTL) describes a circuit at a high level of Boolean functions and data flow within the circuit in a similar manner to a regular programming language. Gate-level descriptions provide a structural (schematic) description of a circuit as an interconnection of basic blocks called gates, whereas every gate has a known and relatively simple Boolean behaviour. Switch-level descriptions usually represent the lowest level of circuit design abstraction which again is a structural (schematic) one and contains an interconnection of switches (transistors) that implement a desired functionality of the circuit.

The RTL is often the preferred abstraction level for most design activities, however, any RTL design has to be translated into an equivalent switch-level design as a necessary step prior to the fabrication of a semiconductor chip. This translation can be performed using so-called synthesis Electronic Design Automation (EDA) tools that compile RTL designs into a predefined, technology-specific gate-level cell library that contains a switch-level schematic for each cell. In some cases, especially when a chip has to meet stringent operating requirements (for example speed and power consumption), certain blocks of the chip may be designed at the switch level.

For a number of reasons, it is highly desirable and advantageous to accurately translate the functionality implemented by a circuit description containing switches into a higher level (gate or RTL). An important application of such a technology is formal functional verification of circuits. Formal functional verification try to ensure that a chip operates as expected based on appropriate mathematical models. Unlike traditional functional verification approaches, such as simulation, formal verification typically provides 100% coverage of a circuit's functionality. To enable formal functional verification at the mixed (switch and gate) level, a method is required to translate the structural description of a circuit into a functional (Boolean) description in the corresponding mathematical model. Other application areas for mixed (switch and gate) level circuit analysis and translation include technology-specific library characterisation, Automatic Test Pattern Generation (ATPG), and re-synthesis and re-design of chips from one chip manufacturing technology to another.

Conventional EDA CAD Tools employing a method to translate the structural description of a circuit into a functional description are critically dependent on the memory consumption and processing time of the analysis to be of practical use. A hierarchical analysis approach aims to utilise the hierarchical structure typically found in industry switch-level circuit designs, and reduce memory consumption and processing time by analysing each logic block in the circuit once only, and in relative isolation to the remainder of the circuit. Various techniques have been developed for the analysis of the behaviour of mixed (switch and gate) level circuits that either flatten the entire hierarchy of a circuit prior to analysis, or flatten portions of the circuit when there are structural loops that span multiple levels of the hierarchy. These techniques result in logic blocks being repeatedly analysed each time they are used.

Tools known as ANAMOS and TRANALYZE described in “Boolean Analysis of MOS Circuits” by R. E. Bryant published in IEEE TCAD, 6(4), pp. 634-649, July 1987, and later refined in “Extraction of Gate-Level Models from Transistor Circuits by Four-Valued Symbolic Analysis” also by R. E. Bryant and published in ICCAD '91 were developed for the purpose of transistor-level simulation and mapping into a hardware-based gate-level simulator. The ANAMOS and TRANALYZE tools do not provide a means for the hierarchical analysis of mixed level circuits. Furthermore, these tools use a technique that flattens the entire hierarchy of a circuit prior to analysis.

Another tool for mixed (gate and switch) level circuit analysis has been described in “Verity a Formal Verification Program for Custom CMOS Circuits” by A. Kuehlmann, A. Srinivasan and D. P. LaPotin published in the IBM R & D Journal, Vol. 39, pp. 149-165, January-March 1995. This tool is a logic checker working at the switch level. The tool does not output an equivalent higher-level model and does not make use of the hierarchy of a switch-level circuit in its analysis. This tool also uses a technique that flattens the entire hierarchy of a design prior to analysis.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for deriving a hierarchical functional description of a circuit, the hierarchical functional description resulting from an initial hardware description comprising transistors, logic gates or combinations thereof that describes the circuit, the method comprising the steps of:

creating a hierarchical model of the circuit from the initial hardware description, said hierarchical model having at least one boundary connection coupling hierarchical levels thereof;

analysing the hierarchical model to identify signal flow conflicts at each said boundary connection;

flattening instances of the hierarchical model where said signal flow conflicts are identified thereby transforming the hierarchical model into a signal flow conflict free hierarchical model; and

deriving a hierarchical functional description of the circuit from the signal flow conflict free hierarchical model.

Suitably, after the step of deriving there may be a further step of creating a hardware description model from the signal flow conflict free hierarchical model.

Preferably, the step of creating a hierarchical model of the circuit may be formed by translating the initial hardware description model into a hierarchy of circuit modules, wherein a lowest hierarchical level comprises base modules that do not contain instances of other modules.

Suitably, said base modules may include one or more logic gates.

Preferably, said base modules may include one or more transistors.

Suitably, the step of creating may be characterised by the hierarchical model having instances of gates at more than one of said levels.

Preferably, the step of creating may be characterised by the hierarchical model having instances of transistors at more than one of said levels.

Suitably, said translating the initial hardware description model may be effected depth-first.

Preferably, said translating the initial hardware description model may be effected recursively.

Suitably, wherein the step of analysing may be characterised by said signal flow conflicts being identified when there is a potential two way signal flow at one or more said boundary connections.

Preferably said signal flow conflicts may be identified when a lower level instance at one side of a hierarchical boundary has a gate output or a transistor channel terminal that is not a sole input or output to an identified boundary connection,

and a higher level instance at another side of said hierarchical boundary has a gate output or a transistor channel terminal coupled to said identified boundary connection.

Suitably, the hierarchical functional description may be free from structural feedback loop information.

Preferably, the step of creating a hierarchical model may be effected automatically.

Suitably, the step of deriving may be characterised by the hierarchical functional description being a RTL description.

### BRIEF DESCRIPTION OF THE DRAWINGS

In order that the invention may be readily understood and put into practical effect, reference will now be made to a preferred embodiment as illustrated with reference to the accompanying drawings in which:

FIGS. 1 to 4 are flowcharts describing a method of deriving a hierarchal functional description of a circuit in accordance with a preferred embodiment of the invention;

FIG. 5 is an example circuit for which the method of FIGS. 1 to 4 can be applied; and

FIG. 6 is a signal flow conflict free hierarchical model of the example circuit of FIG. 5.

### DETAILED DESCRIPTION OF THE PREFERRED EMBODIMENT OF THE INVENTION

In this specification, specific terms of a hierarchical circuit model are defined as follows:

A ‘port’ is a boundary connection that interfaces a hierarchical level with a higher hierarchical level. The type of a port may be one of:

An ‘input’ where signals flow from a higher level in the hierarchy to the port;

An ‘output’ where signals flow from the level containing the port to a higher level in the hierarchy;

An ‘inout’ where signal flow is bidirectional between the level containing the port and a higher level in the hierarchy, though signal can only flow in one direction at a particular time.

An ‘instance’ is an instantiation of a lower hierarchical level. There may be more than one instance of a level of hierarchy in a circuit.

A ‘module’ is a level in the hierarchical model that contains ports coupled to logic gates, transistors or instances or combinations thereof.

A ‘top module’ is the highest level in the hierarchical circuit model.

A ‘base module’ is the lowest level of hierarchical circuit model that contains ports, and logic gates or transistors or combinations thereof. There may be more than one base module in a circuit. A base module may be the top module in the hierarchical circuit model if the circuit contains a single hierarchical level.

A ‘Channel Connected Component’ is a set of nets, transistors and logic gates which are electrically connected through the channel terminals of transistors and the outputs of logic gates; also called CCC.

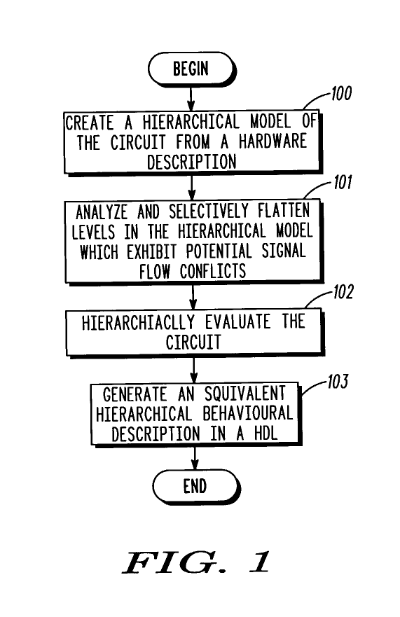

With reference to FIG. 1, there is illustrated method for deriving a hierarchical functional description of a circuit. At step 100, a hierarchical model of the circuit is created from an initial hardware description represented by a Hardware Description Language (HDL) comprising transistors, logic gates or combinations thereof, as will be apparent to a person skilled in the art. The hierarchical model contains one or more modules, with each module possessing information of any instances contained within and has one or more boundary connection coupling hierarchical levels of the model. The hierarchical model is created depth-first and recursively, and typically corresponds closely to the hierarchical structure of the initial hardware description.

In step 101, the hierarchy of the model is traversed from the top module down to the base modules. As the traversal of the hierarchy returns, the net connections at the boundaries of each level are examined for signal flow conflicts. The potential for a signal flow conflict occurs when a Channel Connected Component spans more than one level in the hierarchy, and indicates that the level in the hierarchy cannot be analysed in isolation. Instances of lower modules in the hierarchy are flattened for hierarchical boundaries that exhibit the potential for signal flow conflicts. Thus, step 101 comprises a plurality of steps that include analysing the hierarchical model from a lower level to a higher level to identify signal flow conflicts at each boundary connection coupling level of the hierarchical model then flattening instances of the hierarchical model where signal flow conflicts are identified thereby transforming the hierarchical model into a signal flow conflict free hierarchical model.

After step 101 is completed, step 102 is effected whereby the circuit is evaluated hierarchically to derive a hierarchical functional description of the circuit from the signal flow conflict free hierarchical model. Each module that has one or more non-flattened instances in the hierarchy is analysed in relative isolation. The signal flow conflict free model of the circuit is traversed depth-first and recursively similar to the traversal in step 101 such that the hierarchical model is evaluated from the base modules to the top module.

Within a module, known techniques, for example explicit path enumeration, are used to obtain the pull-up and pull-down conditions at appropriate. As a result of depth-first traversal the lower modules will always be evaluated prior to the evaluation of a higher module, and once only. This allows the evaluation technique to treat instances of lower modules similar to logic gates in that the instance has a known and pre-defined behaviour.

By treating instances similar to Channel Connected Components, structural loops between instances in a module can be evaluated without any such instance being flattened and an equivalent structural loop free behavioural description is generated.

The evaluation of the hierarchical model is automatic and does not require user intervention.

In step 103, an equivalent hierarchical behavioural description is created in a Hardware Description Language (HDL). A structural block is created in the HDL for each module in the signal flow conflict free hierarchical model. Each structural block (depending on the HDL) contains:

A definition of the module including the type of all ports;

A definition of each net in the module;

Zero or more assignments (behavioural descriptions) to nets in the module;

Zero or more instances of logic gates;

Zero or more instances of non-flattened modules;

An end to the module definition.

The equivalent hierarchical behavioural description is free of structural feedback loops.

Upon completion of step 103 the method terminates after creating a hierarchical functional description model of a circuit from the signal flow conflict free hierarchical model, the hierarchical functional description typically being a RTL description and may include gate level modules.

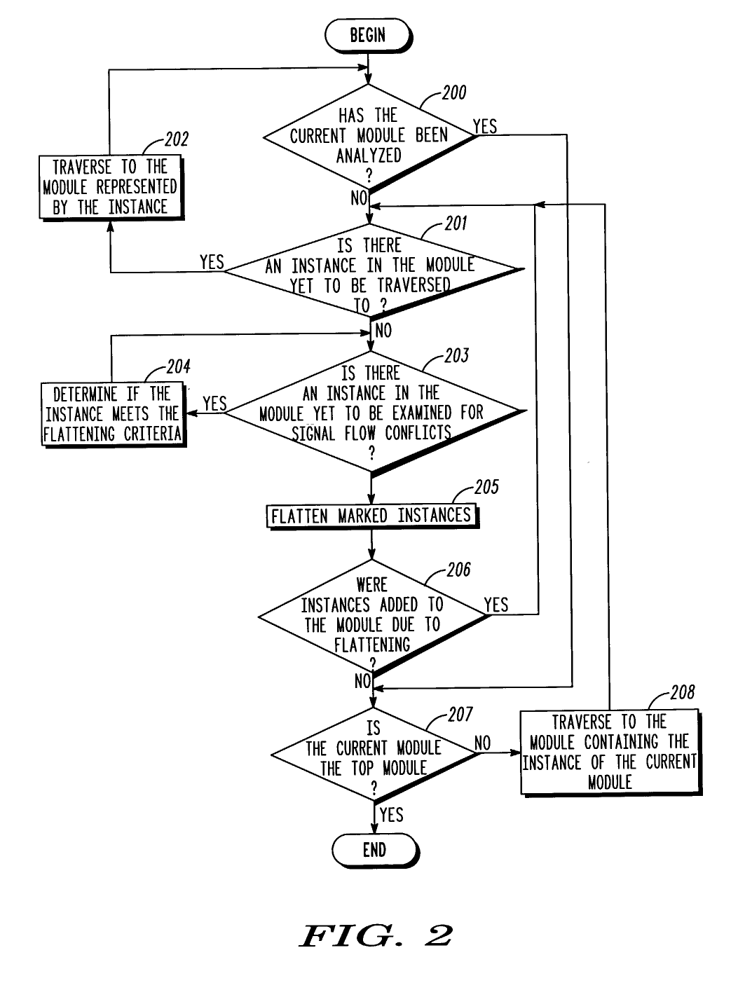

Referring to FIG. 2, a more detailed description of step 101 is described. As illustrated, traversal of the hierarchical model commences at the top module in the circuit. In step 200, the current module in the hierarchy is examined to determine if it has been previously analysed. If the module has been analysed then the method proceeds to step 207, otherwise step 201 is effected.

In step 201, the current module is examined to determine if there are instances of lower modules in the hierarchy that the analysis has yet to traverse. If such an instance is identified the method proceeds to step 202; otherwise it proceeds to step 203.

In step 202, the method traverses to the module represented by the instance identified in step 201. Steps 200, 201 and 202 are executed repeatedly such that the method traverses to a base module in the hierarchy. The method proceeds to step 203 when the traversal has reached a base module, and for each higher module as the traversal returns from the base module.

In step 203, the instances of lower modules are examined to determine if there is an instance whose connections have not been examined for signal flow conflicts with the current module. If such an instance is identified the method proceeds to step 204, otherwise it proceeds to step 205.

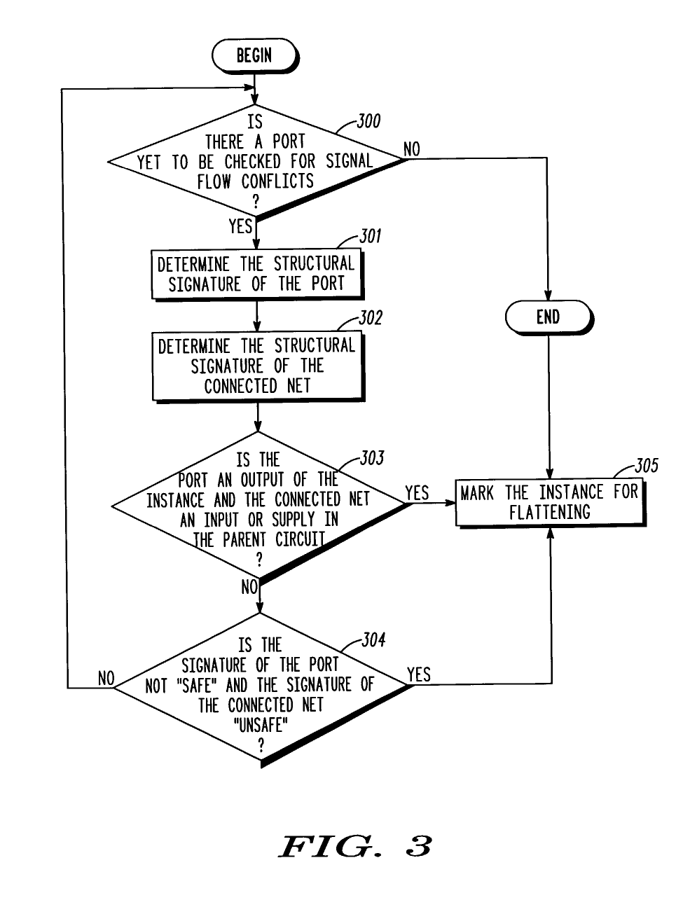

In step 204, the boundary between the instance identified in step 203 and the current module is examined for signal flow conflicts. The boundary comprises of ports within the lower module represented by the instance and the nets connected to those ports in the current module. The boundary between the instance and the current module is examined to determine if the instance meets the criteria for flattening, which includes signal flow conflicts. In step 300 in FIG. 3, the ports of the module represented by the instance are examined to determine if there is a port that has not been checked for signal flow conflicts. If such a port is identified the method proceeds to step 301, otherwise the assessment of the instance against the criteria for flattening is complete and the method returns to step 203.

If the criteria for flattening is incomplete then in step 301 the structural signature of the port is determined. The structural signature of a net describes the structural connections of logic gates, transistors and instances to the net and is used to assess an instance against the criteria for flattening. The structural signature of a net may be one of the following:

‘safe’ which indicates there is no possibility of signals flow conflicts at the net;

‘semi-safe’ which indicates that the net is connected through instances of one or more modules to exactly one net with an ‘unsafe’ structural signature. There is a potential for signal flow conflicts at the net depending on the structural signature of connected nets in higher modules; and

‘unsafe’ which indicates that there is a potential for signal flow conflicts at the net depending on the structural signature of connected nets in higher or lower modules.

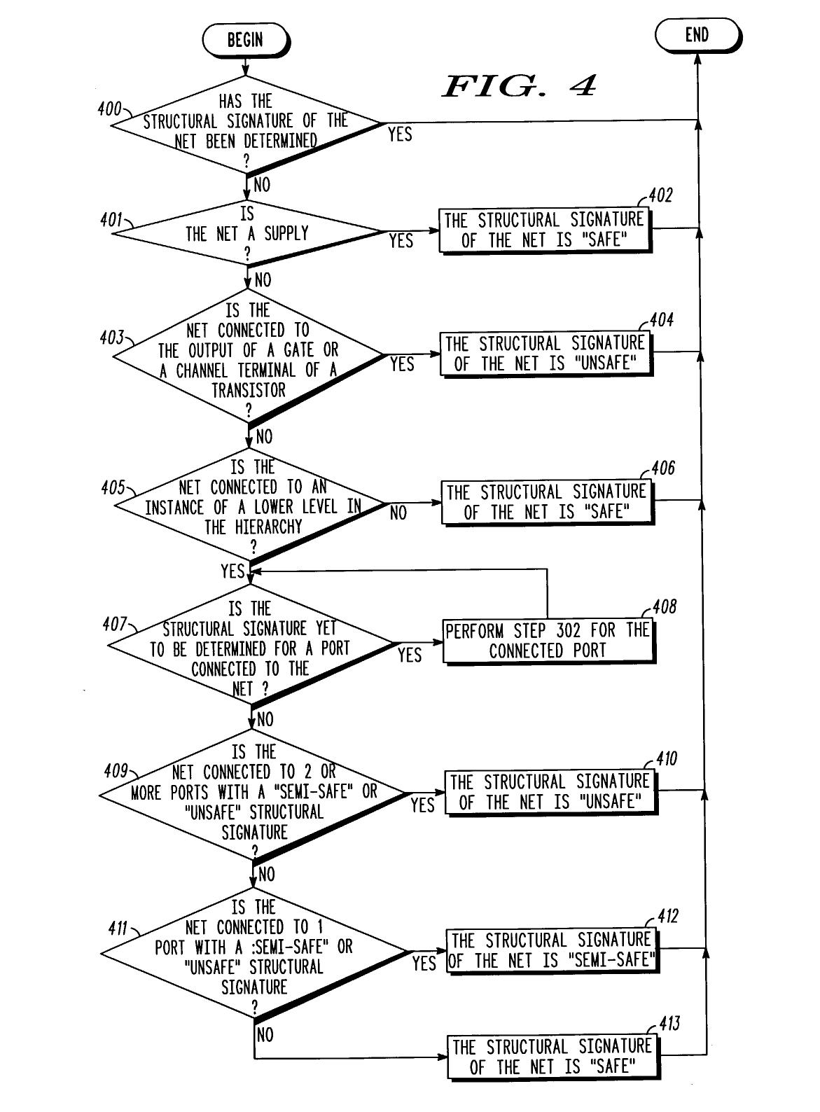

Step 301, the determination of the structural signature of a net, is described in greater detail in FIG. 4.

In step 400 in FIG. 4, the net is checked to see if the structural signature has been previously determined. If the structural signature of the net is not known the method proceeds to step 401.

In step 401, the net is checked to see if it is a supply of logic one or zero. If the net is a supply then the structural signature of the net is ‘safe’ as shown in step 402, otherwise the method proceeds to step 403.

In step 403, the net is examined to determine if it is connected to the output of one or more logic gates or one or more channel terminals of a transistor (Channel Connected Component). If the net has one or more such connections then the structural signature of the net is ‘unsafe’ as shown in step 404, otherwise the method proceeds to step 405.

In step 405, the net is examined to determine if it is within the boundary of any instances in the current module. The net is contained within the boundary if it is connected to one or more ports of modules represented by instances in the current module. If the net is not within the boundary of any instance then the structural signature of the net is ‘safe’ as shown in step 406, otherwise these ports form the set of boundary ports and the method proceeds to step 407.

In step 407, the set of boundary ports is examined to determine if the structural signature is known for all ports in the set. The method proceeds to step 408 if a port with an unknown structural signature is identified. The method proceeds to step 409 when the structural signatures of all boundary ports connected to the net have been determined.

In step 408, the structural signature of the connected port is determined by performing step 302. This is a recursion of the steps shown in FIG. 4. The method proceeds to step 407 once the structural signature of the connected net is determined.

In step 409, if the set of boundary ports contain two or more nets whose structural signatures are ‘semi-safe’ or ‘unsafe’ then the structural signature of the net is ‘unsafe’ as shown in step 410, otherwise the method proceeds to step 411.

In step 411, if the set of boundary ports contain exactly one net whose structural signature is ‘semi-safe’ or ‘unsafe’, and all remaining nets have a ‘safe’ structural signature then the structural signature of the net is ‘semi-safe’ as shown in step 412. Otherwise, the structural signatures of all nets in the set of boundary port set are ‘safe’ and the structural signature of the net is ‘safe’ as shown in step 413.

The method proceeds to step 302 when the structural signature of the port has been determined. In step 302, the structural signature of the net in the current module connected to the port is determined.

Steps 303 and 304 represent the criteria for flattening the instance. In step 303, the port and the connected net are examined to determine if the port is an output of the module represented by the instance, and the connected net is an input port or a supply of logic one or zero in the current module. This condition represents a design problem where the current module expects signals to flow from the input or supply to the instance, and the module represented by the instance is expecting signal flow from the port to the current module. If the condition is met the method proceeds to step 305, otherwise it proceeds to step 304.

In step 304, the structural signatures of the port and connected net are examined to determine if a signal flow conflict is possible between the current module and the instance. If the structural signature of the port is not ‘safe’ and the structural signature of the connected net is ‘unsafe’ then a signal flow conflict is possible. If a signal flow conflict is possible the method proceeds to step 305, otherwise it proceeds to step 300.

In step 305, the instance is marked for flattening. Flattening does not commence until all instances in the current module have been assessed against the criteria for flattening.

Steps 300 to 304 are repeated until a signal flow conflict has been identified for the instance or all ports of the module represented by the instance have been examined. The method then proceeds to step 203 and then to step 205 when the boundaries of all instances in the current module have been examined for signal flow conflicts.

In step 205, all instances that have been marked as a result of step 305 are flattened into the current module. The flattening of an instance involves the addition of all transistors, logic gates, and non-flattened instances contained in the represented module to the current module.

In step 206, the current module is examined to determine if any instances of lower modules were added to the current module as a result of an instance being flattened in step 205. If any such instances were added the method returns to step 201 to ensure that the boundaries between the added instances and the current module are examined and assessed against the criteria for flattening. If no instances were added as a result of flattening in step 205 the method proceeds to step 207.

In step 207, if the current module is not the top module the method proceeds to step 208, otherwise all modules in the hierarchical model have been analysed and the method proceeds to step 102. At this point the hierarchical model has been transformed into a signal flow conflict free hierarchical model.

In step 208 the method traverses up the hierarchy to the module containing the instance of the current module, and the method returns to step 201.

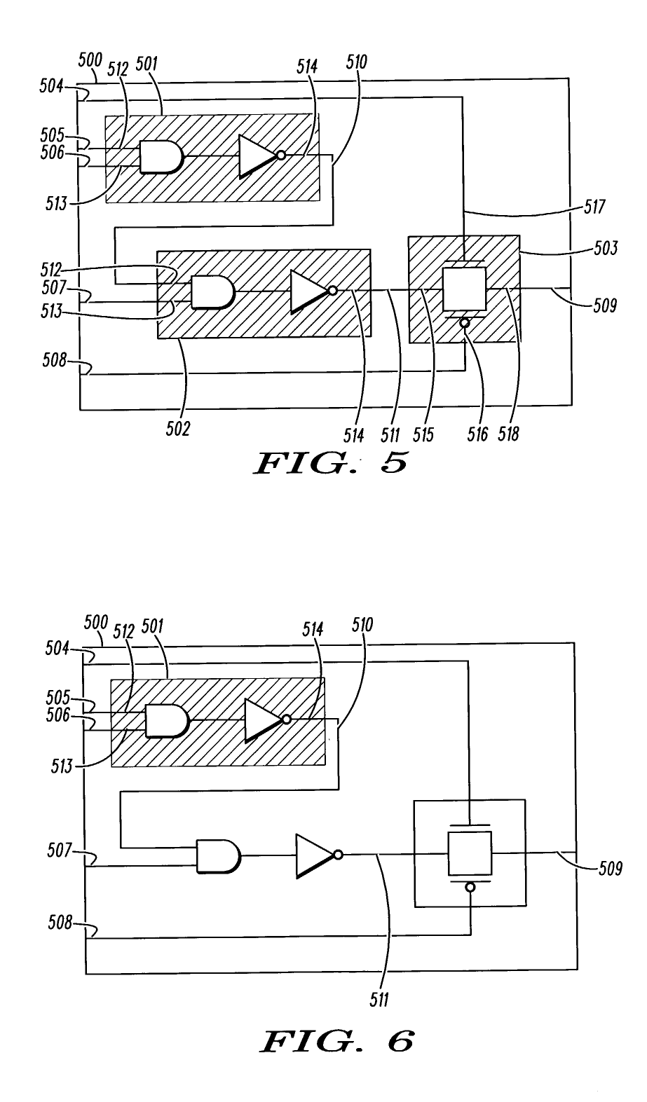

In FIG. 5, this invention is illustrated by way of an example with reference to a simple hierarchical mixed (switch and gate) level circuit implementing basic Boolean logic. It is assumed that the hierarchical model has already been created from the initial hardware description, as described in step 100.

The example comprises of the top module 500 that contains: two instances 501 and 502 of the same base module; one instance 503 of another type of base module; five input ports, 504, 505, 506, 507, and 508; one output port, 509; and two nets 510 and 511 internal to the top module 500. The module represented by instances 501 and 502 contains: an inverter in series with an ‘and’ logic gate; two input ports, 512 and 513; and one output port 514. Ports 512, 513, and 514 are labelled twice due to two instantiations 501 and 502 of the same module. The module represented by instance 503 contains: a cmos transistor; three input ports, 515, 516, and 517; and one output port 518.

In step 101 the analysis of the hierarchical model commences by proceeding to step 200 with the top module 500 being the current module. Module 500 has not been analysed and step 201 is therefore effected. In step 201, instance 501 is selected and in step 202 the method traverses to the module represented by instance 501, proceeding to step 200 for that module.

In step 200, the module represented by instance 501 has not been analysed and the method proceeds to step 201. Instance 501 represents a base module and hence does not contain any instances; the method proceeds through steps 203, 205, and 206 with no modifications to the hierarchical model. In step 207 the current module is not the top module and in step 208 the method traverses up the hierarchy to the top module 500, returning to step 201.

In step 201, instance 502 is selected and in step 202 the method traverses to the module represented by instance 502, proceeding to step 200 for that module.

In step 200, the module has been analysed due to instance 501. In step 207 the current module is not the top module and in step 208 the method traverses to the top module 500, returning to step 201.

In step 201, instance 503 is selected and in step 202 the method traverses to the module represented by instance 503, proceeding to step 200 for that module.

In step 200, the module represented by instance 503 has not been analysed and the method proceeds to step 201. Instance 503 represents a base module and hence does not contain any instances; the method proceeds through steps 203, 205, 206 and 207 with no modifications to the hierarchical model. In step 208 the method traverses up the hierarchy to the top module 500, returning to step 201.

In step 201 there is no instances that have yet to be traversed, execution continues to step 203. In step 203, instance 501 is selected and is assessed against the flattening criteria proceeding to step 204 and thereby effecting step 300.

In step 300, port 512 is selected and in step 301 the structural signature of port 512 is determined to be ‘safe’ (via steps 400, 401, 403, 405, and 406).

In step 302 the structural signature of the net connected to port 512 (net 505) is determined to be ‘safe’ (via steps 400, 401, 403, 405, 407, 409, 411, and 413).

The method proceeds through steps 303 and 304 for port 512 and port 505, returning to step 300 and the selection of port 513. In steps 301 and 302 the structural signatures of port 513 and connected net 506 are both determined to be ‘safe’.

The method returns to step 300 (via steps 303 and 304) and selects port 514. In step 301 the structural signature of net 514 is determined to be ‘unsafe’ (via steps 400, 401, 403, and 404) and in step 302 the structural signature of connected net 510 is determined. This proceeds through steps 400, 401, 403, and 405, to step 407 for net 510. In step 407 the structural signature of each port connected to net 510 (ports 512 and 514) is already determined and the structural signature of net 510 is determined to be ‘semi-safe’ through steps 409, 411 and 412.

The method proceeds through steps 303 and 304 for port 514 and net 510, returning to step 300. There are no remaining ports to check and the method returns to step 203 and selects instance 502.

The method proceeds through steps 300, 301, 302, 303, and 304 for ports 512 and 513 with the result that the signature of port 507 is determined to be ‘safe’.

Returning to step 300 port 514 is selected. In step 301 the structural signature of port 514 is already known to be ‘unsafe’ and in step 302 the structural signature of net 511 connected to port 514 is determined. This results in the structural signatures of port 515 and ultimately net 511 being determined as ‘unsafe’. Proceeding through step 303, in step 304 the port signatures of port 514 and net 511 result in step 305 and instance 502 is marked for flattening. The method returns to step 203 and instance 503 is selected.

In step 300, port 515 is selected. In steps 301 and 302 the structural signature of port 515 and connected net 511 are already known to be ‘unsafe’. Proceeding through step 303, in step 304 the port signatures of port 515 and net 511 result in step 305 and instance 503 is marked for flattening.

The method returns to step 203 where there is no instances remaining to be examined for signal flow conflicts. In step 205, marked instances 502 and 503 are flattened by adding the ‘and’ logic gate, inverter and cmos transistor to module 500. In step 206, it is determined that no instances were added to module 500 due to flattening. In step 207 the current module is the top module 500 hence step 101 completes with a signal flow conflict free hierarchical model of the circuit as shown in FIG. 6, in which module 500 has been modified to contain: non-flattened instance 501; flattened instances 502 and 503; one ‘and’ logic gate; one inverter; and one cmos transistor.

In step 102, the hierarchical model of the circuit is evaluated recursively and depth-first resulting in the evaluation of the module represented by instance 501, followed by module 500. The evaluation results in an equivalent structural loop free behavioural description containing the Boolean values of appropriate nets in the hierarchical model.

In step 103, an equivalent hierarchical behavioural description is created in a HDL, such as the Verilog HDL.

Advantageously the present invention provides a method for deriving a hierarchical functional description of a circuit after flattening instances of a hierarchical model where signals flow conflicts are identified. The derived hierarchical functional description is useful for creating a hardware description model. Signal flow conflict can be identified when a lower level instance at one side of a hierarchical boundary has a gate output or a transistor channel terminal that is not a sole input or output to an identified boundary connection, and a higher level instance at another side of the hierarchical boundary has a gate output or a transistor channel terminal coupled to the identified boundary connection.

Although the invention has been described with reference to a preferred embodiment, it is to be understood that the invention is not restricted to the particular embodiment described herein.

We claim:

1. A method for deriving a hierarchical functional description of a circuit, the hierarchical functional description resulting from an initial hardware description comprising transistors, logic gates or combinations thereof that describes the circuit, the method comprising the steps of:
creating a hierarchical model of the circuit from the initial hardware description, said hierarchical model having at least one boundary connection coupling hierarchical levels thereof;
analysing the hierarchical model to identify signal flow conflicts at each said boundary connection;
flattening instances of the hierarchical model where said signal flow conflicts are identified thereby transforming the hierarchical model into a signal flow conflict free hierarchical model; and
deriving a hierarchical functional description of the circuit from the signal flow conflict free hierarchical model.

2. The method of claim 1, wherein after the step of deriving there is a further step of creating a hardware description model from the signal flow conflict free hierarchical model.

3. The method of claim 1, wherein the step of creating a hierarchical model of the circuit is formed by translating the initial hardware description model into a hierarchy of circuit modules, wherein a lowest hierarchical level comprises base modules that do not contain instances of other modules.

4. The method of claim 3, wherein said base modules include one or more logic gates.

5. The method of claim 3, wherein said base modules include one or more transistors.

6. The method of claim 1, wherein the step of creating is characterised by the hierarchical model having instances of gates at more than one of said levels.

7. The method of claim 1, wherein the step of creating is characterised by the hierarchical model having instances of transistors at more than one of said levels.

8. The method of claim 3, wherein said translating the initial hardware description model is effected depth-first.

9. The method of claim 8, wherein said translating the initial hardware description model is effected recursively.

10. The method of claim 1, wherein the step of analysing is characterised by said signal flow conflicts being identified when there is a potential two way signal flow at one or more said boundary connections.

11. The method of claim 10, wherein said signal flow conflicts are identified when a lower level instance at one side of a hierarchical boundary has a gate output or a transistor channel terminal that is not a sole input or output to an identified boundary connection,
and a higher level instance at another side of said hierarchical boundary has a gate output or a transistor channel terminal coupled to said identified boundary connection.

12. The method of claim 1, wherein the hierarchical functional description is free from structural feedback loop information.

13. The method of claim 1, wherein the step of creating a hierarchical model is effected automatically.

14. The method of claim 1, wherein the step of deriving is characterised by the hierarchical functional description being a RTL description.
